(19) United States
(12) Patent Application Publication
(10) Pub. No.: US 2008/0152969 A1
(43) Pub. Date: Jun. 26, 2008

(54) Detecting and controlling a fuel-rich condition of a reactor in a fuel cell system

(76) Inventors: Vishnu L. Poonamallee, Tamilnadu (IN); Zhi Zhou, Selkirk, NY (US); Parshant Dhand, Lansdale, PA (US); Alan S. Feitelberg, Niskayuna, NY (US)

Correspondence Address: TROP PRUNER & HU, PC, 1616 S. VOSS ROAD, SUITE 750, HOUSTON, TX, 77057-2631, US

(21) Appl. No.: 11/645,154

(22) Filed: Dec. 22, 2006

(51) Int. Cl. H01M 8/04

(52) U.S. Cl. 429/17; 429/34

(57) ABSTRACT

A fuel cell system includes a fuel cell stack, and a reactor to oxidize excess fuel exhausted from the fuel cell stack. A sensor associated with the reactor provides an output indication, and a controller detects a fuel-rich condition of the reactor based on the output indication from the sensor.

### BACKGROUND

This invention generally relates to detecting and controlling a fuel rich condition of a reactor in a fuel cell system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water.

A typical fuel cell has a terminal voltage near one volt DC. For purposes of producing larger voltages, several fuel cells may be assembled together to form an arrangement called a fuel cell stack, an arrangement in which the fuel cells are electrically coupled together in series to form a larger DC voltage and to provide more power.

The fuel cell stack has an anode exhaust to output excess fuel (e.g., excess hydrogen or reformate). To prevent excess fuel from being exhausted into the environment, which is undesirable, a reactor, more specifically an anode tailgas oxidizer (ATO), is provided to oxidize the excess fuel. In addition, the thermal energy or heat generated from oxidizing the fuel in the ATO is used to generate steam for steam reforming for hydrogen or reformate production. To effectively oxidize the excess fuel and generate stable flow of steam with constant temperature, it is desirable to control the ATO's temperature within a predetermined range. However, the challenge associated with operation of the ATO is that it is difficult to control the proper amount of oxidant to achieve satisfactory ATO performance due to complicated ATO dynamics with long response time and strong coupling/interaction of ATO with other components (such as stack, steam circuit or reformer) in the fuel cell system.

### SUMMARY

In general, according to an embodiment, a fuel cell system includes a reactor to oxidize excess fuel, and a sensor associated with the reactor to provide an output indication. A controller detects a fuel-rich condition of the reactor based on the output indication from the sensor.

Advantages and other features will become apparent from the following description, drawings and claims.

### BRIEF DESCRIPTION OF THE DRAWINGS

FIG. 1 is a schematic diagram of a fuel cell system according to an embodiment of the invention.

FIG. 2 is a schematic diagram of a controller that provides control with respect to an anode tailgas oxidizer (ATO), in accordance with some embodiments of the invention.

FIG. 3 is a flow diagram of a process of controlling the ATO, according to an embodiment of the invention.

FIG. 4 is a block diagram of an ATO including a temperature sensor associated with a catalyst of the ATO, in accordance with an embodiment of the invention.

### DETAILED DESCRIPTION

In accordance with some embodiments, a fuel cell system has a reactor to oxidize excess fuel that is output from the exhaust of a fuel cell stack. In some embodiments, the reactor is referred to as an anode tailgas oxidizer (ATO). The ATO is supplied with an oxidant for burning the excess fuel to prevent exhausting the excess fuel into the environment. An issue associated with operation of the ATO is that the ATO may transition to a fuel-rich condition if too much fuel is input into the ATO and/or an insufficient amount of oxidant is provided to the ATO. An example fuel is hydrogen or hydrogen rich reformate, and an example oxidant is air (or oxygen). A sensor is associated with the ATO to provide an output indication. The output indication is received by a controller. The controller determines whether the ATO has entered into a fuel-rich condition based on the output indication of the sensor. Once the controller detects that the ATO has entered into a fuel-rich condition, then the controller takes corrective actions to bring the ATO back to a normal condition (a non-fuel-rich condition, also referred to as a “fuel-lean condition”).

One example of the sensor associated with the ATO is an oxidant sensor that is able to detect oxidant content (e.g., oxygen content) in the gas exhausted from the ATO. In some implementations, the oxidant content is expressed in terms of a relative amount (e.g., percentage) of the oxidant in the overall gas that is exhausted from the ATO. A percentage of oxidant content less than some predefined threshold (e.g., less than 1,000 ppm in the exhaust gas) is indicative of a fuel-rich condition of the ATO. Although the content of fuel (e.g., hydrogen) is not directly measured in the exhaust gas output, the fuel content can be inferred from the oxidant content, such that measured content less than the predefined threshold is indicative of a fuel-rich condition. In some implementations, the oxidant sensor outputs a logical “0” (to indicate fuel-lean condition) or a logical “1” (to indicate fuel-rich condition), or vice versa. In another implementation, the oxidant sensor outputs a value to indicate the relative amount of oxidant in the exhaust gas from the ATO. Note also that a fuel sensor can also optionally be provided to detect content of fuel (e.g., hydrogen) in the exhaust gas to aid in detecting a fuel-rich condition.

In an alternative embodiment, instead of using an oxidant sensor that detects oxidant content in exhaust gas from the ATO, a different sensor is a temperature probe provided inside the ATO (and particularly, at the catalyst of the ATO). The ATO temperature measured by the temperature probe can be used for determining whether the ATO has entered a fuel-rich condition.

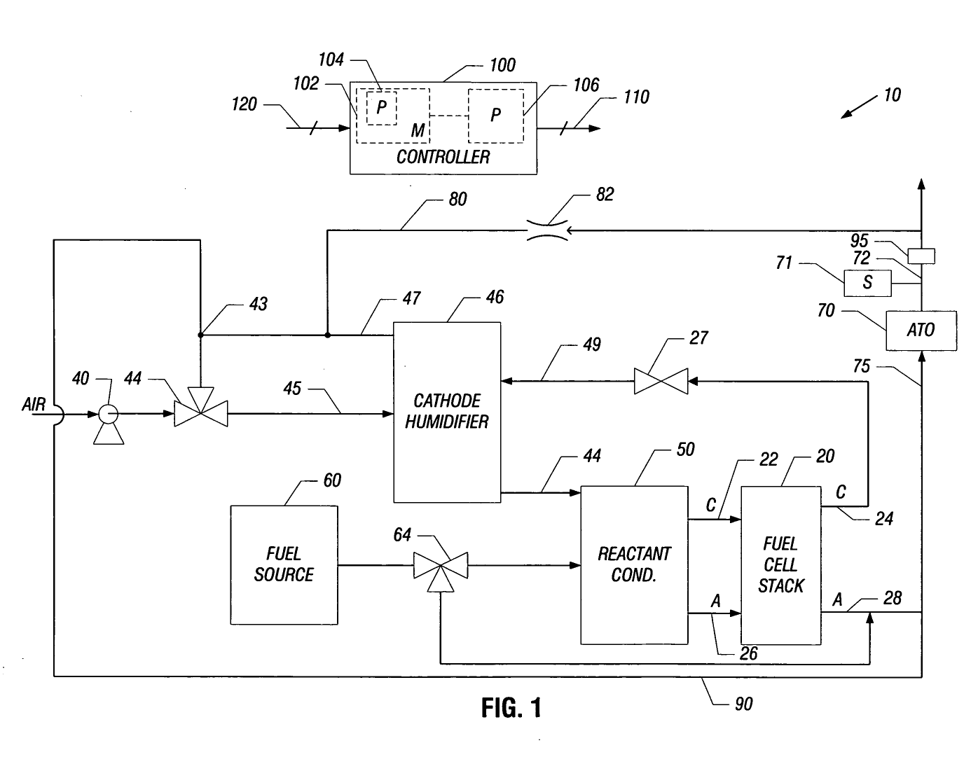

FIG. 1 shows an example fuel cell system 10 according to an embodiment that includes an air blower 40 that furnishes an air flow at its outlet (with air being an example of an oxidant). The oxidant flow that is provided at the output of the air blower 40 is split (or divided) by a three-way valve 44 for purposes of producing oxidant flows to a cathode chamber of a fuel cell stack 20 and to an anode tailgas oxidizer (ATO) 70. A controller 100 of the fuel cell system 10 controls the three-way valve 44 based on a state of the ATO 70 to minimize (or otherwise reduce) the oxidant flow to the fuel cell stack 20 to optimize overall system efficiency. The controller 100 also controls a setting (speed) of the blower 40.

The fuel cell stack 20 includes a cathode inlet 22, which receives the incoming oxidant flow to the stack 20 from a reactant conditioner 50. The incoming oxidant flow passes through the cathode chamber of the fuel cell stack 20, which represents the flow passageways through the cathodes of the fuel cells of the stack 20. The oxidant flow into the cathode inlet 22 produces a corresponding cathode exhaust, which exits the fuel cell stack 20 at a cathode outlet 24. As depicted in FIG. 1, the cathode exhaust may be routed through a valve 27 to a cathode humidifier 46. The cathode humidifier 46 uses the cathode exhaust stream to humidify the incoming oxidant stream to the fuel cell stack. In this regard, the cathode humidifier 46 transfers humidity from the outgoing cathode exhaust to the incoming oxidant stream. As depicted in FIG. 1, the cathode humidifier 46 receives its incoming oxidant stream from an outlet 45 of the three-way valve 44. After being humidified, the oxidant stream passes through the reactant conditioner 50 to the cathode inlet 22 of the fuel cell stack 20. The cathode exhaust exits the cathode humidifier 46 at an exhaust outlet 47, which is connected to a junction 43.

From the junction 43, the cathode exhaust may be combined with a flow from another outlet of the three-way valve 44 to form an oxidant flow to the ATO 70. The oxidant flow to the ATO 70 is provided over a communication line 90. The fuel cell system 10 also includes a bypass line 80, which is connected to the junction 43 for purposes of communicating a flow from the junction 43 to an exhaust flow from the ATO 70. As depicted in FIG. 1, the bypass line 80 may include a flow restrictor orifice 82, which may be a fixed or variable orifice. The function of the bypass line 80 is to limit the maximum oxidant flow through the communication line 90 to the ATO 70. In this regard, an excessively high oxidant flow to the ATO 70 may lower the operating temperature of the ATO 70 outside of an acceptable operator range, thereby reducing oxidation reaction and system efficiency and possibly producing an unacceptably high level of emissions.

The fuel (e.g., hydrogen) for the fuel cell stack 20 is provided by a fuel source 60, which may be a reformer, hydrogen tank, and so forth, depending on the particular implementation. Thus, the fuel cell source 60 may provide a reformate flow, a pure hydrogen flow, etc., depending on the particular source of fuel for the fuel cell stack 20. The fuel flow that is provided by the fuel source 60 passes through a three-way valve 64 and through the reactant conditioner 50. From the reactant conditioner 50, the fuel flow is received into an anode inlet 26 of the fuel cell stack 20. The anode flow is communicated through the anode chamber of the fuel cell stack 20 for purposes of undergoing the electrochemical reactions inside the fuel cell stack 20. The fuel flow through the fuel cell stack 20 produces a corresponding anode exhaust, which exits the fuel cell stack 20 at an anode exhaust outlet 28. As depicted in FIG. 1, the anode exhaust from the fuel cell stack 20 may be combined with the oxidant flow from the communication line 90 to form a feed stock flow which is provided to the ATO 70 for oxidation. The ATO 70 is used to oxidize excess fuel that is exhausted from the anode exhaust outlet 28 of the fuel cell stack 20.

As a result of the oxidation inside the ATO 70, a relatively emission free exhaust flow is produced, which exits the ATO 70 at an outlet 72. As depicted in FIG. 1, in accordance with some embodiments of the invention, an oxidant sensor 95 is located to measure oxidant content of the ATO's exhaust flow. The oxidant sensor 95 provides an output indication to the controller 100, which uses the output indication to determine whether the ATO has entered into a fuel-rich condition.

The ATO 70 is also associated with a temperature sensor 71 to measure the temperature at the exhaust of the ATO 70. As explained further below, the measured temperature provided from the temperature sensor 71 allows the controller 100 to perform temperature feedback control of the oxidant blower 40.

The controller 100 may take on numerous forms, depending on the particular embodiment of the invention. In general, the controller 100 includes a processor 106, which may be formed from one or more microprocessors, microcontrollers, computers, or a combination of these components. In general, the processor 106 executes program instructions 104, which are stored in a memory 102. The memory 102 may be built into the controller 100 or external to the controller 100, depending on the particular embodiment of the invention. The program instructions 104, when executed by the processor 106, cause the controller 100 to perform one or more of the routines to control oxidant flow, which are set forth herein.

The controller 100 includes various input communication lines 120 for purposes of possibly receiving communications from other controllers, readings from sensors, current and voltage measurements, etc. Thus, through the communication lines 120, the controller 100 observes various states, operating conditions and measurements of the fuel cell system 10. Based on these measured parameters and communications, the controller 100 may control various components of the fuel cell system 10, such as the air blower 40, the three-way valves 44 and 64, the orifice 82 (when variable), the valve 27, electrical power conditioning circuitry (not depicted in FIG. 1), the fuel source 60, etc.

The arrangement of FIG. 1 is provided for purposes of illustration. In other implementations, other arrangements of the fuel cell system can be used.

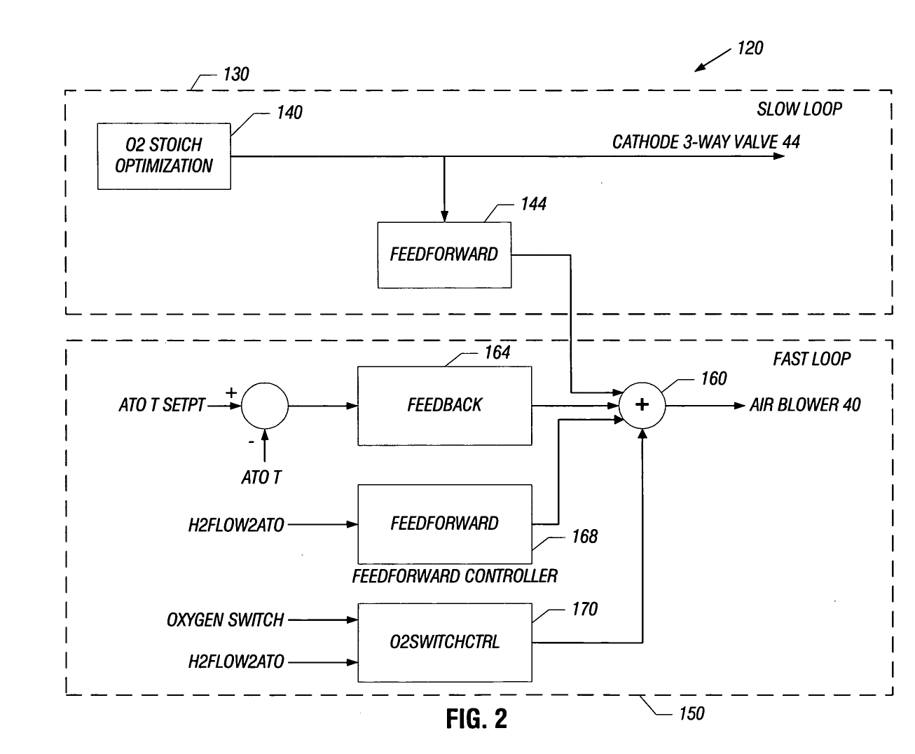

Referring to FIG. 2, in accordance with some embodiments of the invention, the controller 100 (via the execution of the program instructions 104) may implement a control and software architecture 120. Pursuant to the control and software architecture 120, the controller 100 controls the oxidant flows to the ATO 70 and fuel cell stack 20 using two control loops: a relatively slower loop 130, which controls the three-way valve 44 (i.e., controls the division of oxidant flows from the air blower 40 to the ATO 70 and fuel cell stack 20); and a relatively faster loop 150, which controls the speed of the air blower 40. In the slow loop 130, the controller 100 executes an O₂ stoichiometry optimization routine 140 for optimizing the oxidant flow to the fuel cell stack 20. In addition to using the result of the routine 140 to control the three-way valve 44, the controller 100 may also use the result in a feedforward controller routine 144 for purposes of controlling the air blower 40.

In the fast loop 150, the controller 100 controls the speed of the air blower 40 based on several input parameters, one of which may be the feedforward result from the O₂ stoichiometry optimization routine 140. The parameters on which the control of the speed of the air blower 40 is based, may be combined together, as indicated by an adder 160, which provides the speed control signal for the air blower 40.

In addition to the results provided by the feedforward control routine 144, the controller 100 may also consider results provided by a feedback control routine 164, which considers feedback from the ATO 70. In this regard, the feedback control routine 164 generates a control input based on a difference between the ATO temperature (ATO T) 70 (measured by the temperature sensor 71 in FIG. 1, for example) at the exhaust of the ATO, and a predetermined set point (ATO T Setpt), or threshold, temperature. Thus, the actions of the feedback control routine 164 regulate the speed of the air blower 40 based on feedback of the ATO temperature for purposes of regulating the temperature to a predetermined level. Generally, during normal operation, when the temperature sensor 71 indicates that the ATO temperature is increasing, oxidant (e.g., air) flow is increased to reduce the ATO temperature.

In accordance with some embodiments, note that the feedback routine 164 is used during a fuel-lean condition (or normal condition) of the ATO 70. In the fuel-lean condition, an increase in the oxidant flow to the ATO generally results in reduced temperature of the ATO, as measured by the temperature sensor 71 associated with the ATO 70. Because there is no excess fuel, the increase in oxidant flow (e.g., air flow) tends to cool the ATO 70. This effect is a negative feedback effect, in which increase in oxidant flow results in decreased temperature.

However, when the ATO 70 enters a fuel-rich condition, there is excessive fuel content at the ATO such that an increase in oxidant will actually lead to an increase in temperature, due to the fact that the increased oxidant flow will cause the fuel to oxidize right away. Consequently, during fuel-rich operation, the temperature of the ATO can go up relatively quickly if oxidant flow is not controlled properly. Thus, as discussed further below, the feedback control routine 164 is disabled when it is detected that the ATO 70 has entered into a fuel-rich condition.

The regulation of the air blower speed is also based on the result of a feedforward control routine 168 that generates an input to the adder 160 based on an estimated fuel (e.g., hydrogen) flow (represented as H2Flow2ATO) to the ATO 70. In this regard, an estimate is made as to the molar flow of hydrogen that exits the anode exhaust from the fuel cell stack 20 and is provided to the ATO 70.

The fast loop 150 also includes an oxidant switching control routine 170, which receives the estimated hydrogen flow (H2Flow2ATO) to the ATO 70 and a signal from the oxidant sensor 95 (see FIG. 1). The oxidant switching control routine 170 continually determines (based on output of the oxidant sensor 95) whether the ATO 70 is operating in a fuel-lean condition (the normal condition) or a fuel-rich condition (in which the oxidant content falls below some predefined threshold). Upon detecting a fuel-rich condition in the ATO 70, the oxidant switching control routine 170 performs the following corrective actions: (1) disable the feedback control routine 164 such that the feedback control routine 164 does not attempt to increase oxidant flow in response to detecting increasing temperature (as noted above, in the fuel-rich condition, increasing oxidant flow to the ATO will lead to increased temperature (rather than decreased temperature as would occur during the fuel-lean condition); and (2) an oxidant flow is increased by a factor proportional to the amount of fuel flow going to the ATO (as indicated by H2Flow2ATO in FIG. 2) with the amount of oxidant flow increased until the ATO transitions back to the fuel-lean condition.

Once the ATO 70 transitions back from the fuel-rich condition to the fuel-lean condition, the feedback control routine 164 is re-enabled. The output of the oxidant switching control routine 170 is provided as one of the inputs to the adder 160 for controlling the air blower 40 setting.

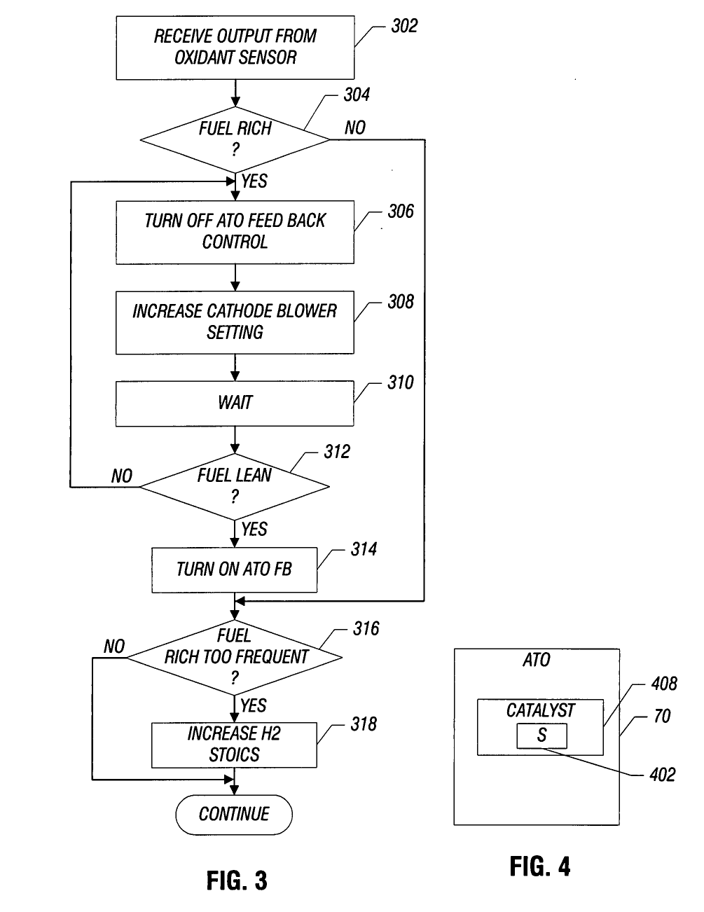

FIG. 3 shows a process according to an embodiment performed by the oxidant switching control routine 170. The oxidant switching control routine 170 receives (at 302) an output indication from the oxidant sensor 95 (FIG. 1). The routine 170 then determines (at 304) whether the ATO 70 has entered a fuel-rich condition. If not, then operation proceeds to task 316 (discussed further below).

However, if the oxidant switching control routine 170 detects (at 304) that the ATO 70 has entered into a fuel-rich condition, then the oxidant switching control routine 170 turns off (at 306) the feedback control routine 164 (FIG. 2). Also, the oxidant switching control routine 170 increases (at 308) the cathode blower setting to increase the speed of the air blower 40 (FIG. 1). The purpose of increasing the air flow by increasing the cathode blower setting is to cause the ATO to transition from the fuel-rich condition to the fuel-lean condition. During the time that the feedback control routine 164 is turned off, control of the ATO 70 relies upon the feedforward controls provided by routines 144 and 168.

The oxidant switching control routine 170 then waits (at 310) for a predefined time duration (e.g., 15 seconds) before checking (at 312) whether the ATO 70 has entered the fuel-lean condition. If not, control proceeds back and the tasks 306, 308, 310 are repeated. However, if the oxidant switching control routine 170 detects (at 312) that the ATO 70 has entered a fuel-lean condition, the oxidant switching control routine 170 turns on the feedback control routine 164 (at 314).

Next, the oxidant switching control routine 170 checks (at 316) to determine whether excursions into the fuel-rich condition are too frequent (e.g., a predetermined number, such as three, excursions in some predefined time interval, such as 10 minutes). If so, the fuel (e.g., hydrogen) stoichiometry is increased (at 318). Increasing the fuel stoichiometry refers to increasing the fuel flow to the fuel cell stack 20 (FIG. 1) at the anode input. Increasing the fuel stoichiometry means that the ratio of fuel supply to the fuel cell stack 20 to the fuel consumed by the fuel cell stack 20 is increased. Note that increasing the fuel stoichiometry also causes the oxidant stoichiometry to be increased. Increasing the oxidant stoichiometry increases oxidant flow into the ATO 70 such that the likelihood of excursions into a fuel-rich condition by the ATO 70 is decreased. Effectively, increasing the fuel stoichiometry at 318 provides a “permanent” offset change to the cathode blower setting. (In this case, the cathode blower setting is “permanently” increased). Note that this increase can be un-done by decreasing the fuel stoichiometry later if desired.

Alternatively, instead of increasing fuel stoichiometry to increase oxidant flow to the ATO 70, the oxidant stoichiometry can be increased independently. This may require adjusting the three-way valve 44 in O2 stoic optimization 140. Or this may require a separate air blower (one for the fuel stack 20 and one of the ATO 70).

Instead of using the oxidant sensor 95 (FIG. 1) to detect oxidant content at the exhaust of the ATO 70, a temperature sensor that is provided inside the ATO 70 can be used instead. The temperature sensor provided in the ATO 70 differs from the temperature sensor 71 (FIG. 1) provided at the exhaust of the ATO 70 to detect temperature in the exhaust. As depicted in FIG. 4, the ATO 70 includes a catalyst 400 that enhances oxidation of the excess fuel provided to the ATO 70. A temperature sensor 402 can be provided with the catalyst 400 to detect temperature at the catalyst 400 of the ATO 70. In one implementation, an opening is drilled in the catalyst 400 to place the temperature sensor 402. Note that the temperature sensor 402, which can be a thermocouple in one example embodiment, provided at the catalyst 400 allows the temperature sensor 402 to detect temperature changes in the ATO 70 much more quickly than the temperature sensor 71 provided at the exhaust output of the ATO 70. There can be delay of several minutes between temperature change inside the ATO 70 and temperature change at the exhaust output of the ATO 70.

To use the temperature sensor 402 provided at the catalyst 400 of the ATO 70, a test is performed during operation of the fuel cell system to determine whether the ATO 70 is in a fuel-rich condition or fuel-lean condition. This test is referred to as a fuel-rich condition test, which is an on-line test in that the test is performed while the fuel cell system 10 is on-line and operational.

When performing the fuel-rich condition test, the feedback control routine 164 (FIG. 2) is disabled. Then, during the test, the air blower 40 setting is adjusted up and down to see how the ATO temperature (as detected by temperature sensor 402) changes. In the fuel-lean region, an increase in the air blower speed causes the ATO temperature to go down, whereas a decrease in air blower speed causes the ATO temperature to go up. On the other hand, in the fuel-rich region, an increase in the speed of the air blower will cause the temperature to go up, whereas a decrease in the speed of the air blower will cause the ATO temperature to go down. Once a fuel-rich condition is detected, then the tasks 306-318 depicted in FIG. 3 can be performed, as discussed above.

Instructions of software described above (including instructions 104 of FIG. 1) are loaded for execution on a processor (e.g., 106 in FIG. 1). The processor includes microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A fuel cell system comprising:
a fuel cell stack;
a reactor to oxidize excess fuel exhausted from the fuel cell stack;
a sensor associated with the reactor to provide an output indication; and
a controller to detect a fuel-rich condition of the reactor based on the output indication from the sensor.

2. The fuel cell system of claim 1, wherein the controller is configured to take corrective action in response to detecting the fuel-rich condition.

3. The fuel cell system of claim 1, wherein the sensor comprises an oxidant sensor to detect oxidant content in exhaust gas from the reactor.

4. The fuel cell system of claim 3, wherein the controller detects the fuel-rich condition in response to oxidant content in the exhaust gas less than a predefined threshold.

5. The fuel cell system of claim 1, wherein in response to detecting the fuel-rich condition, the controller is configured to further:
increase oxidant flow to the reactor.

6. The fuel cell system of claim 5, further comprising an oxidant blower, wherein the oxidant flow is increased by increasing a setting of the oxidant blower.

7. The fuel cell system of claim 5, wherein in response to detecting the fuel-rich condition, the controller is configured to further:
disable feedback control for the reactor, wherein the feedback control adjusts oxidant flow in response to a temperature of the reactor.

8. The fuel cell system of claim 7, wherein the controller is configured to further:
determine whether the reactor has returned to a fuel-lean condition; and
in response to determining that the reactor has returned to the fuel-lean condition, enable the feedback control for the reactor.

9. The fuel cell system of claim 1, wherein the reactor comprises an anode tailgas oxidizer.

10. The fuel cell system of claim 9, further comprising an oxidant blower and a three-way valve connected to receive oxidant flow from the output of the oxidant blower, and to divide oxidant flow between a cathode input of the fuel cell stack and the anode tailgas oxidizer.

11. The fuel cell system of claim 10, wherein the controller is configured to adjust a setting of the oxidant blower in response to detecting the fuel-rich condition.

12. The fuel cell system of claim 1, wherein the reactor comprises a catalyst, and wherein the sensor comprises a temperature sensor provided at the catalyst.

13. The fuel cell system of claim 12, further comprising an oxidant blower, wherein the controller is configured to perform a test that changes a setting of the oxidant blower to determine whether the reactor is in the fuel-rich condition.

14. The fuel cell system of claim 13, wherein the controller is configured to increase the setting of the oxidant blower to determine whether the temperature sensor indicates that the temperature of the reactor increases or decreases, wherein the fuel-rich condition is indicated if the temperature of the reactor increases with increase in the speed of the oxidant blower.

15. The fuel cell system of claim 1, wherein the controller is configured to further:
detect whether the reactor has entered the fuel-rich condition too frequently; and
in response to detecting that the reactor has entered the fuel-rich condition too frequently, increase a fuel stoichiometry of the fuel cell system.

16. The fuel cell system of claim 1, wherein the controller is configured to further:
detect whether the reactor has entered the fuel-rich condition too frequently; and
in response to detecting that the reactor has entered the fuel-rich condition too frequently, increase an oxidant stoichiometry of the fuel cell system.

17. A method for use in a fuel cell system, comprising:
oxidizing, with a reactor, excess fuel exhausted from a fuel cell stack;
receiving an output indication from a sensor associated with the reactor;
detecting whether the reactor has entered a fuel-rich condition in response to the output indication; and
performing a corrective action in response to detecting that the reactor has entered a fuel-rich condition.

18. The method of claim 17, wherein taking the corrective action comprises increasing oxidant flow to the reactor.

19. The method of claim 18, wherein taking the corrective action further comprises disabling feedback control based on temperature of the reactor.

20. The method of claim 17, wherein detecting that the reactor has entered the fuel-rich condition is in response to detecting that oxidant content of exhaust gas from the reactor is less than a predefined threshold.

21. The method of claim 17, wherein receiving the output indication from the sensor comprises receiving the output indication from an oxidant sensor.

22. The method of claim 17, wherein receiving the output indication from the sensor comprises receiving a temperature indication from a temperature sensor.

23. The method of claim 17, wherein taking the corrective action comprises adjusting a setting of an oxidant blower in the fuel cell system.

24. An article comprising at least one storage medium that contains instructions for use in a fuel cell system, the instructions when executed causing a controller to:
receive an output indication from a sensor associated with a reactor, wherein the reactor oxidizes excess fuel exhausted from a fuel cell in the fuel cell system;
detect whether the reactor has entered a fuel-rich condition in response to the output indication; and
perform a corrective action in response to detecting that the reactor has entered a fuel-rich condition.
